(19) United States
(12) Patent Application Publication
(10) Pub. No.: US 2020/0074007 A1
(43) Pub. Date: Mar. 5, 2020

(54) Timeline of Events in Search Based System

(71) Applicant: Google LLC, Mountain View, CA (US)

(72) Inventors: Kishore Ananda Papineni, CARMEL, NY (US); Pratik Worah, New York, NY (US)

(21) Appl. No.: 16/117,752

(22) Filed: Aug. 30, 2018

(51) Int. Cl. G06F 17/30

(52) U.S. Cl. CPC G06F 17/30867; G06F 17/30705; G06F 17/30696; G06F 17/30997

(57) ABSTRACT

Methods, systems, and apparatus, including computer programs encoded on a computer storage medium, for providing a timeline in response to search terms. In one aspect, a method includes receiving a query that includes search terms and time constraints and determining multiple time intervals from the time period, and for each time interval, receiving data identifying resources that are responsive to the search terms and that each have a publication date that specifies a date that is within the time interval, and determining, from the identified resources for the time interval, a number of the resources that are hosted by a host that belongs to a predefined category. The method includes selecting time intervals for which the respective number of identified resources for the respective time interval meets a selection threshold and providing a graphical depiction of the selected time intervals as a response to the query.

### FIELD

This specification relates to handling queries from users.

### BACKGROUND

Computing systems may handle various queries from users. For example, a query may be in form of a sequence of words that make up a search query and a computing system may, in response to receiving the search query, provide search results responsive to the search query. For example, in response to the search query “Isaac Asimov books,” a system may provide search results in the form of a list of websites that describe books by Isaac Asimov.

### SUMMARY

A system may provide a timeline in response to search terms. A timeline may be a graphical depiction of the chronology of a sequence of events. For example, a user may input search terms of “John Doe” and a time period of “Apr. 30, 2016 to Apr. 30, 2018.” In response, the system may provide a timeline in the form of a graphical depiction of significant events relevant to the search terms “John Doe” that occurred between the time period of Apr. 30, 2016 and Apr. 30, 2018. The timeline may enable users to easily see the chronological relationship between the events.

To generate the timeline, the system may leverage a search engine that is configured to identify resources that are responsive to search terms. For example, the system may leverage a pre-existing search engine that is configured to receive search terms, optionally time constraints that specify a time period, and optionally host constraints that specify requirements for hosts of resources and, in response, provide a web page of search results that list hyperlinks to resources, e.g., webpages, images, video, etc., where each resource is relevant to the search terms, is published within the time period if specified, and is hosted on a host that satisfies the requirements for hosts if specified.

The system may leverage the search engine so that functionality for searching does not need to be separately implemented for generating a timeline. One advantage of leveraging a search engine may be that functionality for searching may use a large amount of storage space and computing power. For example, to provide search functionality, millions of webpages may need to be indexed by webcrawlers and then selected from when responding to a query. Another advantage may be that computing power needed to timely respond to queries may require specialized hardware that is dedicated for searching. Accordingly, leveraging an existing search engine may avoid the need for the system to include additional storage space and specialized hardware beyond that already provided by an existing search engine.

Another advantage is an improved user interface that increases the efficiency of using an electronic device by bringing together a limited list of search results that can each be accessed directly from a timeline display. Displaying the particular search results in a timeline window allows the user to see the most relevant data for particular time periods without having to submit multiple, separate queries. This speeds up a user's navigation through various search results, which is an improvement because it saves the user from navigating to multiple search results and submitting multiple time constrained queries. Thus, rather than paging through multiple sets of search results for various time period searches that are separately submitted by the user, only one search request is required from the user. This is especially useful for devices with small display screens.

In general, one innovative aspect of the subject matter described in this specification can be embodied in methods that include the actions of receiving, from a client device, a query that includes search terms and time constraints that specify a time period for which results responsive to the search terms were published and determining multiple time intervals from the time period, each of the multiple time intervals being a proper subset of the time period. Further actions include, for each time interval of the multiple time intervals, providing, to a search engine, the search terms and time constraints that specify the time interval, receiving, from the search engine, data identifying resources that are responsive to the search terms and that each have a publication date that specifies a date that is within the time interval, and determining, from the identified resources for the time interval, a number of the resources that are hosted by a host that belongs to a predefined category. Additional actions include selecting time intervals for which the respective number of identified resources for the respective time interval meets a selection threshold, generating a graphical depiction of the selected time intervals and, for each respective selected time interval, a search result that identifies a resource that is responsive to the search terms for the respective selected time interval, and providing, to the client device, the graphical depiction of the selected time intervals as a response to the query.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In certain aspects, selecting time intervals for which the respective number of identified resources for the respective time interval meets a selection threshold includes determining that the respective number of identified resources for the respective time interval is more than a predefined number and in response to determining that the respective number of identified resources for the respective time interval is more than the predefined number, selecting the respective time interval. In some implementations, selecting time intervals for which the respective number of identified resources for the respective time interval meets a selection threshold includes selecting a predefined number of the respective time intervals with a highest number of identified resources for the respective time interval.

In some aspects, generating a graphical depiction of the selected time intervals and, for each respective selected time interval, a search result that identifies a resource that is responsive to the search terms for the respective selected time interval includes for each selected time interval of the selected time intervals, providing, to the search engine, the search terms, time constraints that specify the selected time interval, and host constraints that specify a second predefined category of host, receiving, from the search engine, data identifying second resources responsive to the search terms, that each have a publication date that specifies a date that is within the selected time interval, and that each are hosted by a host that belongs to the second predefined category of host, and selecting, from the second resources, a particular second resource that is indicated by the search engine as most responsive to the search terms, and generating the graphical depiction of the selected time intervals that includes a search result that corresponds to each of the selected particular second resources.

In certain aspects, generating a graphical depiction of the selected time intervals and, for each respective selected time interval, a search result that identifies a resource that is responsive to the search terms for the respective selected time interval includes generating the graphical depiction of the selected time intervals to depict the search results that identify the resources that are responsive to the search terms for the respective selected time intervals in chronological order of publication. In some implementations, determining, from the identified resources for the time interval, a number of the resources that are hosted by a host that belongs to a predefined category includes determining a number of the resources that have universal resource locators that include an indicator of a host in a list of hosts of the predefined category. In some aspects, the time intervals are non-overlapping and together span an entirety of the time period. In certain aspects, providing, to the client device, the graphical depiction of the selected time intervals as a response to the query includes providing, the client device, the graphical depiction of the resources in the selected time intervals as a response to the query.

Particular embodiments of the subject matter described in this specification can be implemented so as to realize one or more of the following advantages.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example system that provides a timeline in response to search terms.

FIG. 2 is an example of a timeline provided in response to search terms.

FIG. 3 is a flow diagram that illustrates an example of a process for providing a timeline in response to search terms.

FIG. 4 is a diagram of examples of computing devices.

Like reference numbers and designations in the various drawings indicate like elements.

### DETAILED DESCRIPTION

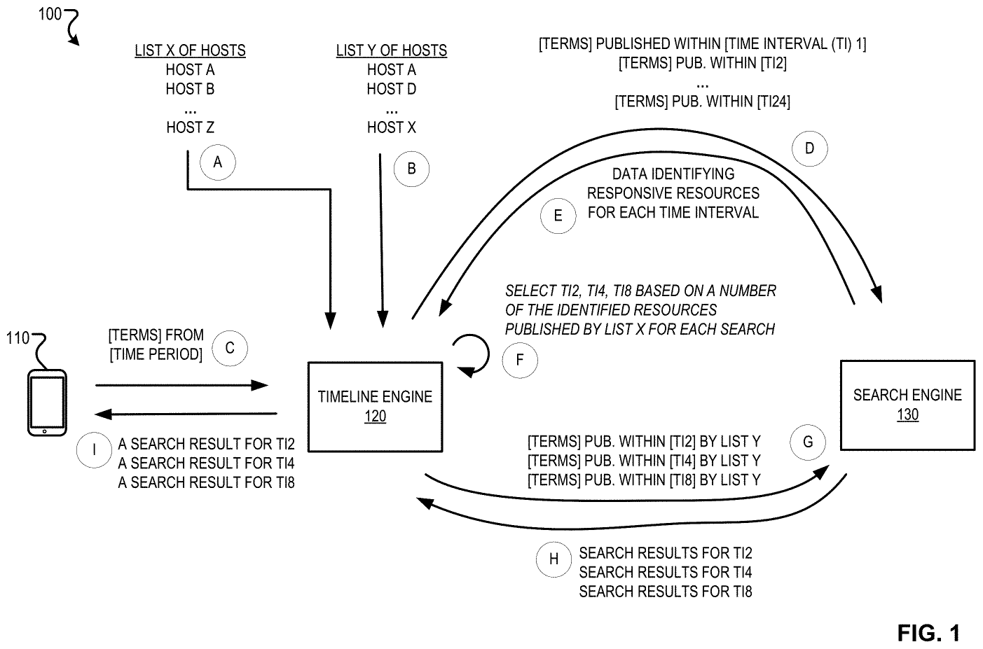

FIG. 1 is a block diagram that illustrates an example system 100 that provides a timeline in response to search terms. Briefly, and as will be described below in more detail, the system 100 includes a client device 110, a timeline engine 120, and a search engine 130.

The client device 110 may be used by a user to input a query for a timeline and display results of the query. For example, the client device 110 may be used by a user to type in search terms of “[TERMS]” and a time period of “[TIME PERIOD]” and the system may provide a timeline in the form of a graphical depiction of significant events relevant to “[TERMS]” that occurred during the “[TIME PERIOD].” A query may include search terms, optionally time constraints that specify a time period, and optionally host constraints that specify requirements for hosts of resources. In some implementations, the client device 110 may be a mobile computing device, a desktop computer, a tablet, a laptop computer, or some other type of computing device.

The client device 110 may provide the query to the timeline engine 120 (Stage C), receive a timeline from the timeline engine 120 in response to the query (Stage I), and then show the timeline on a display of the client device 110. For example, the client device 110 may receive search terms, represented by “[TERMS]” input by a user, and a time period, represented by “[TIME PERIOD]” input by a user, and provide the query “[TERMS] FROM [TIME PERIOD]” to the timeline engine 120, then receive a timeline that graphically depicts three resources that correspond to three different time intervals during the time period, and then display the timeline.

The timeline engine 120 may obtain a first list of hosts that belong to a first predefined category (Stage A) and a second lists of hosts that belong to a second predefined category (Stage B). For example, the first list of hosts, “List X,” may include hosts A through Z that are all news websites and the second list of hosts, “List Y” may include hosts A, D, E, G, X that are a list of the most popular news websites, where the set of hosts in List Y is a proper subset of the set of hosts in List X. In other examples, the first list of hosts may include a list of twenty academic journal websites and the second list of hosts may include only the five most popular academic journal websites. The timeline engine 120 may obtain the lists from storage where the list may be defined in advance by an administrator. The first list may be used by the timeline engine 120 to determine whether an event of significance happened during a time interval and the second list may be used by the timeline engine 120 to identify a resource published on a reputable host.

The timeline engine 120 may obtain the query (Stage C). For example, the timeline engine 120 may be implemented on a server that is remote from the client device 110 and receive the query of “[TERMS] from [TIME PERIOD]” over the Internet. The timeline engine 120 may provide the search engine 130 the search terms of the query and time constraints for each of multiple time intervals during the time period (Stage D). For example, the timeline engine 120 may provide the search engine 130 search terms of “[TERMS]” published within “[TIME INTERVAL 1] (TI1),” “[TERMS]” published within “[TI2],” . . . , “[TERMS]” published within “[TI24].” Each pair of search terms and time constraints may be considered a separate search. The timeline engine 120 may provide the search terms and time constraints in parallel so that the search engine 130 may determine and provide results to each of the pairs of search terms and time constraints in parallel, which may result in taking less time than iteratively providing the search terms and time constraints to the search engine 130 after receiving responses from the search engine 130 to previously provided search terms and time constraints.

The timeline engine 120 may receive data identifying responsive resources for each time interval from the search engine 130 (Stage E). For example, for each time interval, the timeline engine 120 may receive a webpage that lists universal resource locators (URLs) of twenty resources published during the time interval that the search engine 130 determined were the twenty most relevant resources to the search terms. Each of the resources listed may be considered a search result and the list of resources considered search results.

The timeline engine 120 may select time intervals based on a number of identified resources published by hosts in the first list for each search (Stage F). For example, the timeline engine 120 may select TI2, TI4, and TI8 based on determining that those time intervals were the three time intervals that, in their corresponding search results, had the most number of resources accessed with a URL indicating a host listed in List X. The timeline engine 120 may select time intervals based on a number of identified resources published by hosts in the first list for each search as the number may be indicative of a likelihood that an event occurred that was both significant and relevant to the search terms. For example, if many search results in a particular time interval were from news websites, then it may be more likely that an event of significance happened than another time interval where fewer search results were from news websites.

The timeline engine 120 may provide the search engine 130 the search terms of the query, time constraints for each of the selected time intervals, and host constraints that require resources be published by a host listed in the second list (Stage G). For example, the timeline engine 120 may provide the search engine 130 search terms of “[TERMS],” time constraints that specify resources be published within “[TI2],” and host constraints that specify a host of the resource must be in List Y, “[TERMS],” time constraints that specify resources be published within “[TI4],” and host constraints that specify a host of the resource must be in List Y, and “[TERMS],” time constraints that specify resources be published within “[TI8],” and host constraints that specify a host of the resource must be in List Y.

The timeline engine 120 may then receive the search results for each selected time interval from the search engine 130 (Stage H). For example, for each selected time interval, the timeline engine 120 may receive a webpage that lists URLs of twenty resources published during the selected time interval that the search engine 130 determined were the twenty most relevant resources to the search terms.

The timeline engine 120 may then generate a graphical depiction of the selected time intervals and provide the graphical depiction to the client device 110 (Stage I). For example, the timeline engine 120 may take the resource indicated as most relevant in the search results for each of the selected time intervals, order the most relevant resources by the chronological date the resources were published, and provide a representation of each resource according to the chronological dates.

In some implementations, the client device 110 may not require that a user input search terms and a time period. For example, the client device 110 may enable a user to view a resource and select a link to view a timeline of events relevant to topics discussed in the resource. The timeline engine 120 may then receive an indication of the selection of the link and then generate a query based on the resource. For example, the timeline engine 120 may generate a query by analyzing text or metadata in a resource about “John Doe,” selecting important terms of “John Doe” in the resource as the search terms based on the analysis, and determining a time period of two months, six months, twenty four months, or some other length of time for the query.

Additionally or alternatively, in some implementations the timeline engine 120 may receive a query that specifies search terms and a single time. For example, the query may specify the year 1960. The timeline engine 120 may be able to determine a second time so that the single time and the second time form the bounds of a time period. For example, the timeline engine 120 may receive the search terms “Event X” with a specified time of no earlier than the year 2012. In the example, the timeline engine 120 may then provide the search terms and the time constraints of no earlier than the year 2012 to the search engine, receive back data identifying resources that are responsive, and then determine that the second date is 2008, which corresponds to when developments related to “Event X” first began. The timeline engine 120 may determine the second time based on determining a drop in density of resources identified as responsive in relation to the second time. For example, the timeline engine 120 may determine that the earliest identified resource that is a resource hosted by a host that belongs to a predefined category was published in 2008 so determine 2008 as the second time, and then use the search terms and time period of 2008 to 2012 as described above.

In another example, the timeline engine 120 may receive the search terms “Event Y” with time constraints of no later than the year 2009, provide the search terms and time constraints to a search engine, receive back data identifying resources responsive, determine that less than 10% of the resources hosted by a host that belongs to a predefined category were published after 2014, in response determine the time period as 2009 to 2014, and then use the search terms and time period of 2009 to 2014 as described above.

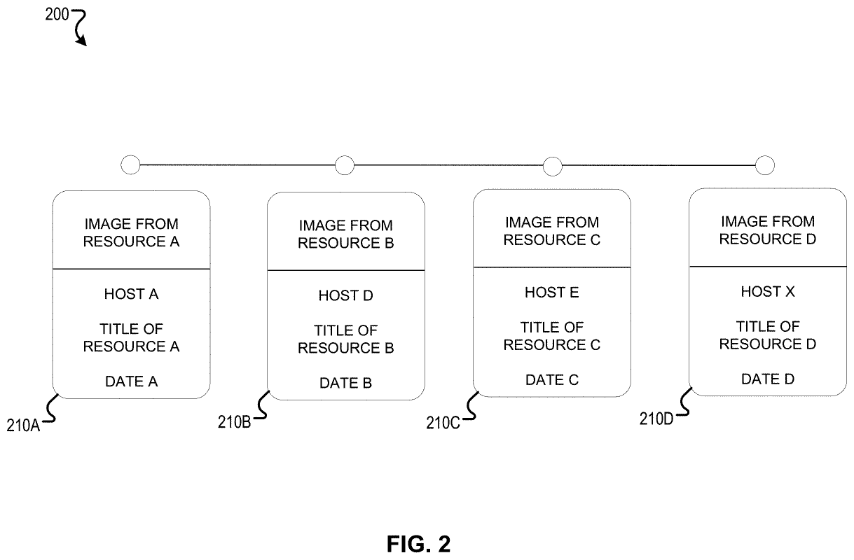

FIG. 2 is an example of a timeline 200 provided in response to search terms. The timeline 200 may be a graphical depiction of significant events relevant to search terms that occurred during a time period. The timeline 200 may include a representation of a resource for each time interval that a timeline engine selected to include in the timeline 200. For example, a timeline may include a representation of “Resource A” for a first selected time interval 210A, a representation of “Resource B” for a second selected time interval 210B, a representation of “Resource C” for a third selected time interval 210C, and a representation of “Resource D” for a fourth selected time interval 210D. Each representation may be in a form of a graphical box where a top half of the box may include a thumbnail of an image referenced by the resource and a bottom half of the box may include a name of the host, title of the resource, and a date that the resource was published. The timeline 200 may include the representations chronologically ordered so that the left most representation is the most recently published resource, the second left most representation is the second most recently published resource, the third left most representation is the third most recently published resource, and the right most representation is the least recently published resource. The timeline 200 may include circles above each representation 210A-210D where the circles are connected to each other by a single line.

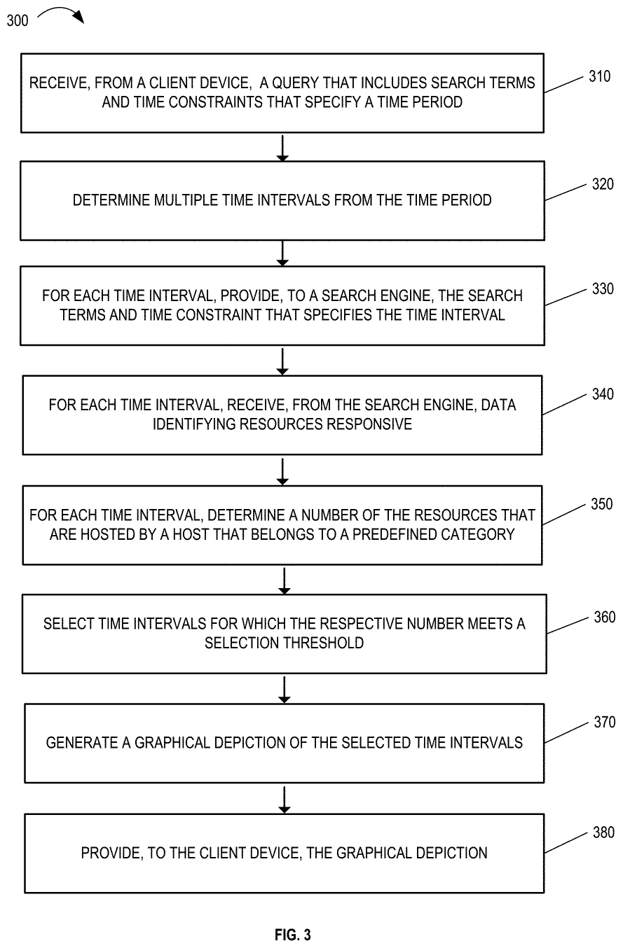

FIG. 3 is a flow diagram of a process 300 for providing contextual information for a displayed resource. For example, the process 300 may be used by the timeline engine 120 from the system 100.

The process 300 includes receiving, from a client device, a query that includes search terms and time constraints that specify a time period (310). For example, the timeline engine 120 may receive from the client device a query that includes search terms of “John Doe” and time constraints that specify a time period of “Apr. 30, 2016 to Apr. 30, 2018.” In some implementations, the time constraints are explicitly specified, such as described above. In other implementations, the system may add time constraints to the query automatically. The time constraints so added may be a default period, e.g., the previous year, or may be pre-specified based on a subject of a query. For example, if the query is “The Second World War,” the time constraints that may be added are “September 1939-September 1945.”

The process 300 includes determining multiple time intervals from the time period (320). For example, the timeline engine 120 may determine twenty four time intervals that each correspond to a month, e.g., a first time interval of Apr. 30, 2016 to May 30, 2016, a second time interval of May 31, 2016 to Jun. 30, 2016, etc. The time intervals may be non-overlapping and together span an entirety of the time period. In some implementations, the process 300 may include determining ten, twenty, some other predefined number of time intervals with similar durations from the time period.

The process 300 includes, for each time interval, providing, to a search engine, the search terms and time constraint that specifies the time interval (330). For example, the timeline engine 120 may provide to the search engine 130 search terms of “John Doe” and time constraints that specify a time interval of “Apr. 30, 2016 to May 30, 2016,” search terms of “John Doe” and time constraints that specify a time interval of “May 31, 2016 to Jun. 30, 2016,” etc.

The process 300 includes, for each time interval, receiving, from the search engine, data identifying resources responsive (340). For example, the timeline engine 120 may receive from the search engine 130 a first set of search results to search terms of “John Doe” and time constraints that specify a time interval of “Apr. 30, 2016 to May 30, 2016,” a second set of search results to search terms of “John Doe” and time constraints that specify a time interval of “May 31, 2016 to Jun. 30, 2016,” etc.

The process 300 includes, for each time interval, determining a number of the resources that are hosted by a host that belongs to a predefined category (350). For example, the timeline engine 120 may determine that eighteen out of twenty resources identified in the second set of search results have a URL that indicates the host is a host in List X, determine that seventeen out of twenty resources identified in the fourth set of search results have a URL that indicates the host is a host in List X, etc. In some implementations, determining, from the identified resources for the time interval, a number of the resources that are hosted by a host that belongs to a predefined category includes determining a number of the resources that have universal resource locators that include an indicator of a host in a list of hosts of the predefined category. For example, the timeline engine 120 may determine that the first set of search results identifies two resources with URLs that begin with a host of any of hosts A-Z.

The process 300 includes selecting time intervals for which the respective number meets a selection threshold (360). For example, the timeline engine 120 may select the second, fourth, and eighth time intervals. In some implementations, selecting time intervals for which the respective number of identified resources for the respective time interval meets a selection threshold includes determining that the respective number of identified resources for the respective time interval is more than a predefined number and in response to determining that the respective number of identified resources for the respective time interval is more than the predefined number, selecting the respective time interval. For example, the timeline engine 120 may select eight time intervals based on determining that those eight time intervals had more than twelve identified resources hosted by a host in List X, and not select the remaining sixteen time intervals based on determining that those sixteen time intervals had twelve or fewer identified resources hosted by a host in List X.

In some implementations, selecting time intervals for which the respective number of identified resources for the respective time interval meets a selection threshold may include selecting a predefined number of the respective time intervals with a highest number of identified resources for the respective time interval. For example, the timeline engine 120 may order the time intervals by the number of identified resources hosted by a host in List X and then select a three, four, six, or some other number of the top time intervals, which correspond to the time intervals with the highest numbers.

The process 300 includes generating a graphical depiction of the selected time intervals (370). For example, the timeline engine 120 may generate the timeline shown in FIG. 2. In some implementations, generating a graphical depiction of the selected time intervals and, for each respective selected time interval, a search result that identifies a resource that is responsive to the search terms for the respective selected time interval includes, for each selected time interval of the selected time intervals, providing, to the search engine, the search terms, time constraints that specify the selected time interval, and host constraints that specify a second predefined category of host, receiving, from the search engine, data identifying second resources responsive to the search terms, that each have a publication date that specifies a date that is within the selected time interval, and that each are hosted by a host that belongs to the second predefined category of host, and selecting, from the second resources, a particular second resource that is indicated by the search engine as most responsive to the search terms, and generating the graphical depiction of the selected time intervals that includes a search result that corresponds to each of the selected particular second resources.

For example, the timeline engine 120 may provide to the search engine 130 search terms of “John Doe,” time constraints that specify a time interval of “May 31, 2016 to Jun. 30, 2016,” and host constraints that specify to only identify resources hosted by a host in List Y, the same search terms, time constraints that specify a time interval of “Jul. 31, 2016 to Aug. 30, 2016, the same host constraints, and continue for each selected time interval. The timeline engine 120 may receive back different sets of search results for each selected time interval, select the resource identified as the most relevant resource in each set of search results, and then generate the timeline 200 where each selected resource is shown as a representation 210.

In some implementations, generating a graphical depiction of the selected time intervals and, for each respective selected time interval, a search result that identifies a resource that is responsive to the search terms for the respective selected time interval includes generating the graphical depiction of the selected time intervals to depict the search results that identify the resources that are responsive to the search terms for the respective selected time intervals in chronological order of publication. For example, the timeline engine 120 may generate the timeline 200 where the identified resources for each selected time interval are shown in chronological order, where left is mostly recently published and right is least recently published.

The process 300 includes providing, to the client device, the graphical depiction (380). For example, the timeline engine 120 may provide the timeline shown in FIG. 2 to the client device 110 over the Internet.

In some implementations, the process 300 may include dynamic determining the time intervals from the time period. For example, the timeline engine 120 may dynamically determine a length of time intervals based on the number of the identified resources that are hosted by a host that belongs to a predefined category for the time intervals. The process 300 may include determining that a particular time interval of the time intervals determined had many identified resources that are hosted by a host that belongs to a predefined category and, in response, divide the particular time interval into two or more shorter time intervals, then provide the search engine the search terms and the time constraints that specify the shorter time intervals, and use the results of the shorter time intervals instead of the results from the initial time intervals.

For example, the timeline engine 120 may determine that a second time interval from an initial set of time intervals determined from the time period had seventeen resources that are hosted by a host that belongs to a predefined category, in response, split the second time interval into two shorter time intervals, provide the search terms and time constraints to the search engine for a first one of the shorter time intervals and in parallel provide the search terms and time constraints to the search engine for a second one of the shorter time intervals, receive data identifying resources responsive for the shorter time intervals, and then select time intervals from the initial time intervals besides the second time interval and the shorter time intervals split from the second time interval.

In another example, the timeline engine 120 may determine that a second time interval had seventeen resources that are hosted by a host that belongs to a predefined category and that the other time intervals had fewer than five resources that are hosted by a host that belongs to a predefined category and, in response, use the second time interval as the time period in restarting the process 300. In some implementations, the process 300 may include a minimum length of time for time intervals. For example, a minimum length of any time interval may be two days.

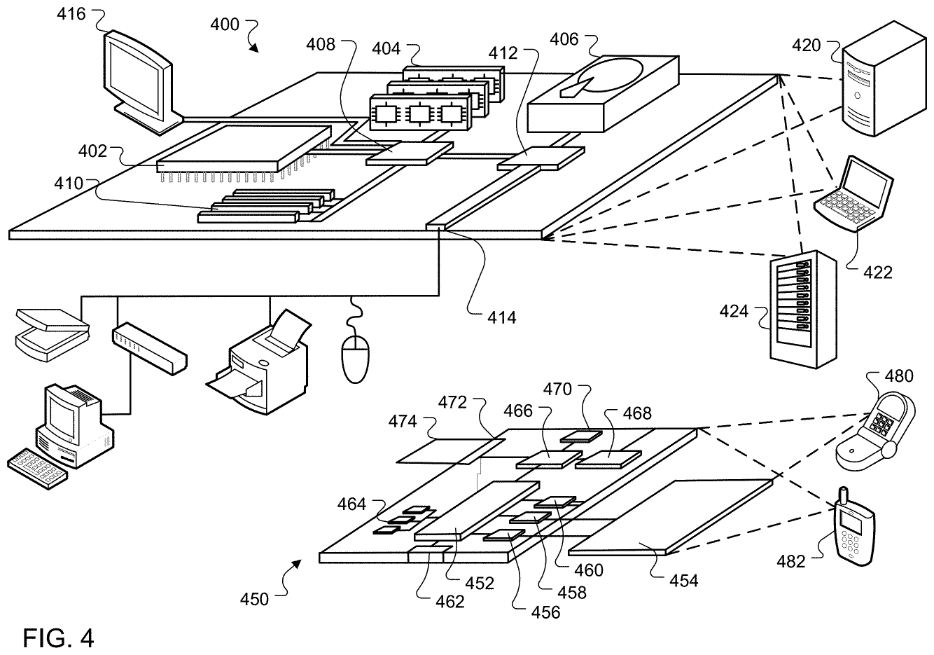

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used herein, the terms “machine-readable medium” “computer-readable medium” refers to any computer program product, apparatus and/or device, e.g., magnetic discs, optical disks, memory, Programmable Logic devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving, from a client device, a query that includes search terms and time constraints that specify a time period for which results responsive to the search terms were published;
determining multiple time intervals from the time period, each of the multiple time intervals being a proper subset of the time period;
for each time interval of the multiple time intervals:
providing, to a search engine, the search terms and time constraints that specify the time interval;
receiving, from the search engine, data identifying resources that are responsive to the search terms and that each have a publication date that specifies a date that is within the time interval;
determining, from the identified resources for the time interval, a number of the resources that are hosted by a host that belongs to a predefined category;
selecting time intervals for which the respective number of identified resources for the respective time interval meets a selection threshold;
generating a graphical depiction of the selected time intervals and, for each respective selected time interval, a search result that identifies a resource that is responsive to the search terms for the respective selected time interval; and
providing, to the client device, the graphical depiction of the selected time intervals as a response to the query.

2. The method of claim 1, wherein selecting time intervals for which the respective number of identified resources for the respective time interval meets a selection threshold comprises:
determining that the respective number of identified resources for the respective time interval is more than a predefined number; and
in response to determining that the respective number of identified resources for the respective time interval is more than the predefined number, selecting the respective time interval.

3. The method of claim 1, wherein selecting time intervals for which the respective number of identified resources for the respective time interval meets a selection threshold comprises:
selecting a predefined number of the respective time intervals with a highest number of identified resources for the respective time interval.

4. The method of claim 1, wherein generating a graphical depiction of the selected time intervals and, for each respective selected time interval, a search result that identifies a resource that is responsive to the search terms for the respective selected time interval comprises:
for each selected time interval of the selected time intervals:
providing, to the search engine, the search terms, time constraints that specify the selected time interval, and host constraints that specify a second predefined category of host;
receiving, from the search engine, data identifying second resources responsive to the search terms, that each have a publication date that specifies a date that is within the selected time interval, and that each are hosted by a host that belongs to the second predefined category of host; and
selecting, from the second resources, a particular second resource that is indicated by the search engine as most responsive to the search terms; and
generating the graphical depiction of the selected time intervals that includes a search result that corresponds to each of the selected particular second resources.

5. The method of claim 1, wherein generating a graphical depiction of the selected time intervals and, for each respective selected time interval, a search result that identifies a resource that is responsive to the search terms for the respective selected time interval comprises:
generating the graphical depiction of the selected time intervals to depict the search results that identify the resources that are responsive to the search terms for the respective selected time intervals in chronological order of publication.

6. The method of claim 1, wherein determining, from the identified resources for the time interval, a number of the resources that are hosted by a host that belongs to a predefined category comprises:
determining a number of the resources that have universal resource locators that include an indicator of a host in a list of hosts of the predefined category.

7. The method of claim 1, wherein the time intervals are non-overlapping and together span an entirety of the time period.

8. The method of claim 1, wherein providing, to the client device, the graphical depiction of the selected time intervals as a response to the query comprises:
providing, the client device, the graphical depiction of the resources in the selected time intervals as a response to the query.

9. A system comprising:
a data processing apparatus; and
a non-transitory computer readable storage medium in data communication with the data processing apparatus and storing instructions executable by the data processing apparatus and upon such execution cause the data processing apparatus to perform operations comprising:
receiving, from a client device, a query that includes search terms and time constraints that specify a time period for which results responsive to the search terms were published;
determining multiple time intervals from the time period, each of the multiple time intervals being a proper subset of the time period;
for each time interval of the multiple time intervals:
providing, to a search engine, the search terms and time constraints that specify the time interval;
receiving, from the search engine, data identifying resources that are responsive to the search terms and that each have a publication date that specifies a date that is within the time interval;
determining, from the identified resources for the time interval, a number of the resources that are hosted by a host that belongs to a predefined category;
selecting time intervals for which the respective number of identified resources for the respective time interval meets a selection threshold;
generating a graphical depiction of the selected time intervals and, for each respective selected time interval, a search result that identifies a resource that is responsive to the search terms for the respective selected time interval; and
providing, to the client device, the graphical depiction of the selected time intervals as a response to the query.

10. The system of claim 9, wherein selecting time intervals for which the respective number of identified resources for the respective time interval meets a selection threshold comprises:
determining that the respective number of identified resources for the respective time interval is more than a predefined number; and
in response to determining that the respective number of identified resources for the respective time interval is more than the predefined number, selecting the respective time interval.

11. The system of claim 9, wherein selecting time intervals for which the respective number of identified resources for the respective time interval meets a selection threshold comprises:
selecting a predefined number of the respective time intervals with a highest number of identified resources for the respective time interval.

12. The system of claim 9, wherein generating a graphical depiction of the selected time intervals and, for each respective selected time interval, a search result that identifies a resource that is responsive to the search terms for the respective selected time interval comprises:
for each selected time interval of the selected time intervals:
providing, to the search engine, the search terms, time constraints that specify the selected time interval, and host constraints that specify a second predefined category of host;
receiving, from the search engine, data identifying second resources responsive to the search terms, that each have a publication date that specifies a date that is within the selected time interval, and that each are hosted by a host that belongs to the second predefined category of host; and
selecting, from the second resources, a particular second resource that is indicated by the search engine as most responsive to the search terms; and
generating the graphical depiction of the selected time intervals that includes a search result that corresponds to each of the selected particular second resources.

13. The system of claim 9, wherein generating a graphical depiction of the selected time intervals and, for each respective selected time interval, a search result that identifies a resource that is responsive to the search terms for the respective selected time interval comprises:
generating the graphical depiction of the selected time intervals to depict the search results that identify the resources that are responsive to the search terms for the respective selected time intervals in chronological order of publication.

14. The system of claim 9, wherein determining, from the identified resources for the time interval, a number of the resources that are hosted by a host that belongs to a predefined category comprises:
determining a number of the resources that have universal resource locators that include an indicator of a host in a list of hosts of the predefined category.

15. The system of claim 9, wherein the time intervals are non-overlapping and together span an entirety of the time period.

16. The system of claim 9, wherein providing, to the client device, the graphical depiction of the selected time intervals as a response to the query comprises:
providing, the client device, the graphical depiction of the resources in the selected time intervals as a response to the query.

17. A non-transitory computer readable storage medium storing instructions executable by a data processing apparatus and upon such execution cause the data processing apparatus to perform operations comprising:
receiving, from a client device, a query that includes search terms and time constraints that specify a time period for which results responsive to the search terms were published;
determining multiple time intervals from the time period, each of the multiple time intervals being a proper subset of the time period;
for each time interval of the multiple time intervals:
providing, to a search engine, the search terms and time constraints that specify the time interval;
receiving, from the search engine, data identifying resources that are responsive to the search terms and that each have a publication date that specifies a date that is within the time interval;
determining, from the identified resources for the time interval, a number of the resources that are hosted by a host that belongs to a predefined category;
selecting time intervals for which the respective number of identified resources for the respective time interval meets a selection threshold;
generating a graphical depiction of the selected time intervals and, for each respective selected time interval, a search result that identifies a resource that is responsive to the search terms for the respective selected time interval; and
providing, to the client device, the graphical depiction of the selected time intervals as a response to the query.

18. The medium of claim 17, wherein selecting time intervals for which the respective number of identified resources for the respective time interval meets a selection threshold comprises:
determining that the respective number of identified resources for the respective time interval is more than a predefined number; and
in response to determining that the respective number of identified resources for the respective time interval is more than the predefined number, selecting the respective time interval.

19. The medium of claim 17, wherein selecting time intervals for which the respective number of identified resources for the respective time interval meets a selection threshold comprises:
selecting a predefined number of the respective time intervals with a highest number of identified resources for the respective time interval.

20. The medium of claim 17, wherein generating a graphical depiction of the selected time intervals and, for each respective selected time interval, a search result that identifies a resource that is responsive to the search terms for the respective selected time interval comprises:
for each selected time interval of the selected time intervals:
providing, to the search engine, the search terms, time constraints that specify the selected time interval, and host constraints that specify a second predefined category of host;
receiving, from the search engine, data identifying second resources responsive to the search terms, that each have a publication date that specifies a date that is within the selected time interval, and that each are hosted by a host that belongs to the second predefined category of host; and
selecting, from the second resources, a particular second resource that is indicated by the search engine as most responsive to the search terms; and
generating the graphical depiction of the selected time intervals that includes a search result that corresponds to each of the selected particular second resources.
